(19) United States
(12) Patent Application Publication
(10) Pub. No.: US 2020/0246963 A1
(43) Pub. Date: Aug. 6, 2020

(54) TOOL BOX SHIELD ASSEMBLY

(71) Applicant: Scott Smith, Kitchener (CA)

(72) Inventor: Scott Smith, Kitchener (CA)

(21) Appl. No.: 16/267,501

(22) Filed: Feb. 5, 2019

(51) Int. Cl. B25H 3/02

(52) U.S. Cl. CPC B25H 3/021; A45C 13/002

(57) ABSTRACT

A tool box shield assembly for protecting contents of a tool box from debris and contaminants includes a tool box that has a front side, a top side and a bottom side, and the front side has a plurality of drawers therein. A shield unit is positioned on the tool box and the shield unit is urgeable into a deployed position has the shield unit covering the front side of the tool box. In this way the shield unit protects the drawers in the tool box from dirt and debris. The shield unit is biased into a stored position having the front side of the tool box being exposed.

### CROSS-REFERENCE TO RELATED APPLICATIONS

### Statement Regarding Federally Sponsored Research or Development

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to shield devices and more particularly pertains to a new shield device for protecting contents of a tool box from debris and contaminants.

### BRIEF SUMMARY OF THE INVENTION

An embodiment of the disclosure meets the needs presented above by generally comprising a tool box that has a front side, a top side and a bottom side, and the front side has a plurality of drawers therein. A shield unit is positioned on the tool box and the shield unit is urgeable into a deployed position has the shield unit covering the front side of the tool box. In this way the shield unit protects the drawers in the tool box from dirt and debris. The shield unit is biased into a stored position having the front side of the tool box being exposed.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a tool box shield assembly according to an embodiment of the disclosure.

FIG. 2 is a front view of an embodiment of the disclosure.

FIG. 3 is a phantom view of shield unit of an embodiment of the disclosure.

FIG. 4 is a cross sectional view taken along line 4-4 of FIG. 3 of an embodiment of the disclosure.

FIG. 5 is a cross sectional view taken along line 5-5 of FIG. 3 of an embodiment of the disclosure.

### DETAILED DESCRIPTION OF THE INVENTION

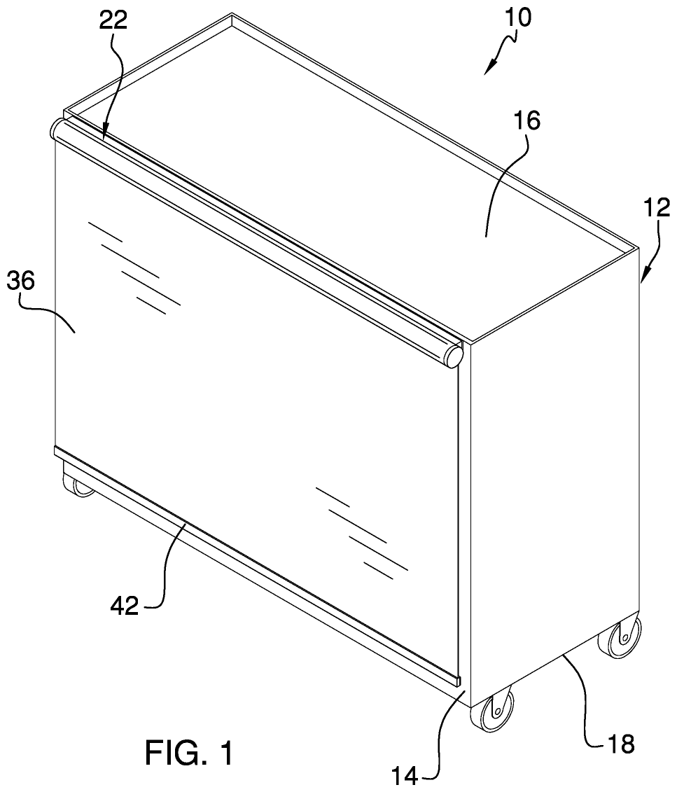

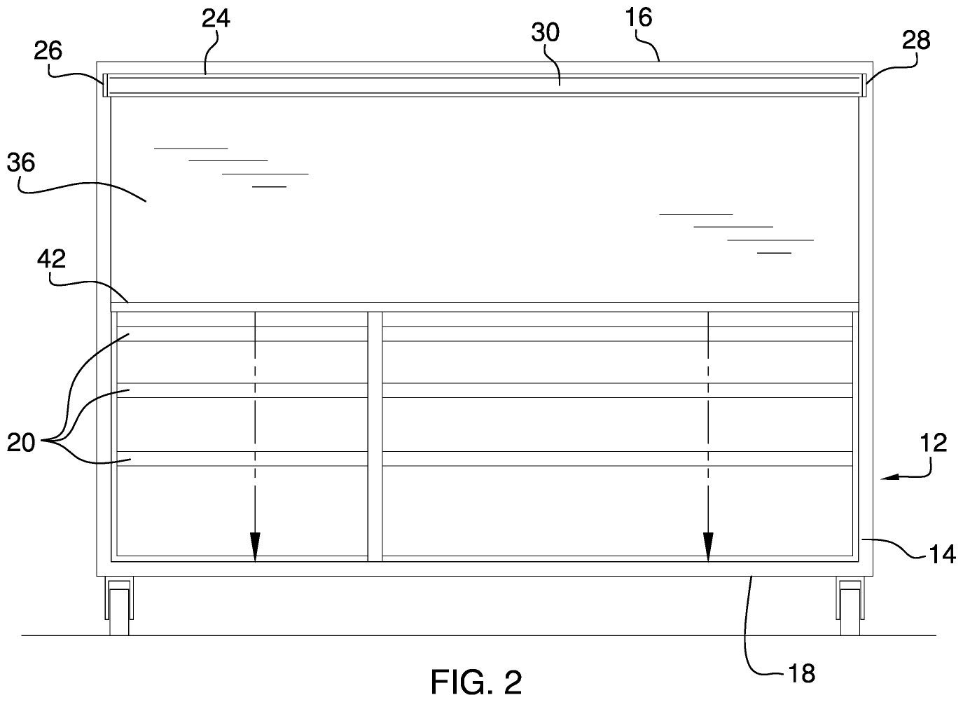

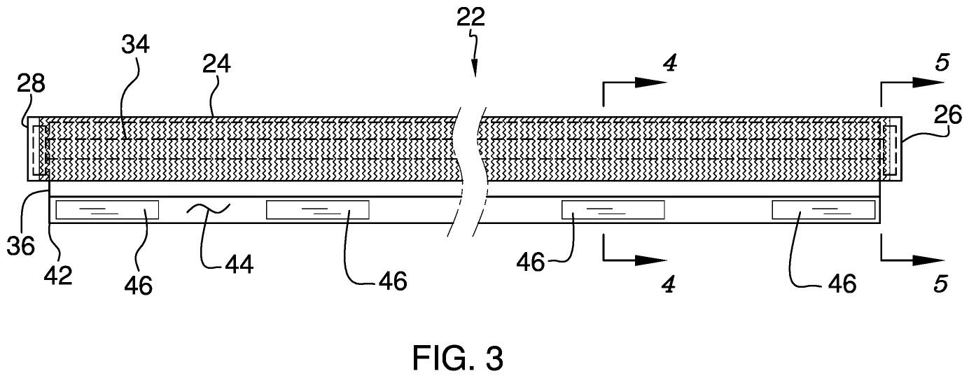

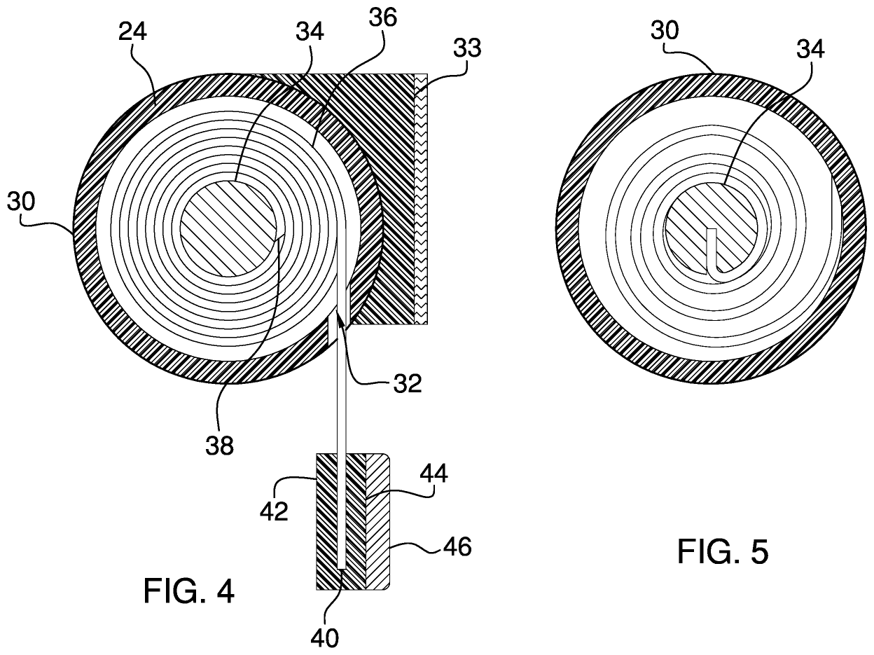

With reference now to the drawings, and in particular to FIGS. 1 through 5 thereof, a new shield device embodying the principles and concepts of an embodiment of the disclosure and generally designated by the reference numeral 10 will be described.

As best illustrated in FIGS. 1 through 5, the tool box shield assembly 10 generally comprises a tool box 12 that has a front side 14, a top side 16 and a bottom side 18, and the front side 14 has a plurality of drawers 20 therein. The tool box 12 may be an upright tool box that would commonly be found in an automotive repair shop, a manufacturing shop and any other industrial environment. Additionally, the tool box 12 may be a tool box that is mounted on a service truck or the like, and the tool box 12 may be a fastener storage unit mounted on a wall of a building. The tool box 12 may be any storage unit for storing objects in an environment that involves routine exposure to dirt, debris, grease, oil and other contaminants.

A shield unit 22 is provided and the shield unit 22 is positioned on the tool box 12. The shield unit 22 is urgeable into a deployed position having the shield unit 22 covering the front side 14 of the tool box 12. In this way the shield unit 22 shields the drawers 20 in the tool box 12 from dirt, debris and other contaminants. The shield unit 22 is biased into a stored position having the front side 14 of the tool box 12 being exposed. Thus, the drawers 20 in the tool box 12 can be opened to access objects contained in the tool box 12.

The shield unit 22 comprises a housing 24 that has a first end 26, a second end 28 and an outer wall 30 extending therebetween. The outer wall 30 has a slot 32 extending into an interior of the housing 24, and the slot 32 extends between the first end 26 and the second end 28. The housing 24 is coupled to the front side 14 of the tool box 12 having the housing 24 being horizontally oriented and being aligned with the top side 16 of the tool box 12. Additionally, the slot 32 is directed toward the bottom side 18 of the tool box 12. The outer wall 30 of the housing 24 has a flattened portion 33 that is coupled to the front side 14 of the tool box 12.

The shield unit 22 includes a spool 34 that is rotatably positioned within the housing 24 and the spool 34 is biased to rotate in a first direction. Additionally, the spool 34 is urgeable to rotate in a second direction. The spool 34 is oriented to be collinear with the slot 32 and the spool 34 may be a spring loaded spool 34 or the like. The shield unit 22 includes a sheet 36 that has a first edge 38 and a second edge 40. The first edge 38 is coupled to the spool 34 and the sheet 36 is rolled around the spool 34 when the spool 34 rotates in the first direction such that the sheet 36 is stored within the housing 24. The spool 34 rotates in the second direction when the sheet 36 is drawn downwardly to cover the front side 14 of the tool box 12.

A member 42 is coupled to the sheet 36 and the member 42 is aligned with and is coextensive with the second edge 40 of the sheet 36. The member 42 abuts the outer wall 30 of the housing 24 when the spool 34 rotates in the first direction. Thus, the member 42 is accessible to be gripped for drawing the sheet 36 outwardly from the housing 24. The member 42 has a first surface 44 facing the front side 14 of the tool box 12. Moreover, the member 42 is aligned with the bottom side 18 of the tool box 12 when the sheet 36 is drawn downwardly from the housing 24 to cover the front side 14 of the tool box 12. The spool 34 may lock to inhibit the spool 34 from rotating in the second direction when the sheet 36 is drawn downwardly to the bottom side 18 of the tool box 12. Additionally, the spool 34 may unlock when the sheet 36 is briefly tugged downwardly thereby facilitating the spool 34 to rotate in the second direction.

A plurality of magnets 46 is included and each of the magnets 46 is coupled to the first surface 44 of the member 42. Each of the magnets 46 magnetically engages the front side 14 of the tool box 12 when the sheet 36 is drawn downwardly along the front side 14 of the tool box 12. Thus, the magnets 46 retain the sheet 36 to cover the front side 14 of the tool box 12. The magnets 46 are spaced apart from each other and are distributed along an entire length of the member 42.

In use, the outer wall 30 of the housing 24 is coupled to the front side 14 of the tool box 12 with any desired fastener, such as screws, hook and loop fasteners and any other releasable fastener. The member 42 is gripped and the sheet 36 is drawn downwardly along the front side 14 of the tool box 12 when the tool box 12 is done being used. Thus, the sheet 36 covers the front side 14 of the tool box 12 and inhibits dust, debris and other contaminants from entering the drawers 20. The magnets 46 magnetically engage the front side 14 of the tool box 12 when the sheet 36 is drawn downwardly to retain the sheet 36 against the front side 14 of the tool box 12. The member 42 is separated from the front side 14 of the tool box 12 to facilitate the spool 34 to draw the sheet 36 into the housing 24 when the tool box 12 needs to be used.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A tool box shield assembly being retractably drawn downwardly on a tool box to shield drawers in the tool box, said assembly comprising:
a tool box having a front side, a top side and a bottom side, said front side having a plurality of drawers therein; and
a shield unit being positioned on said tool box, said shield unit being urgeable into a deployed position having said shield unit covering said front side of said tool box wherein said drawers in said tool box are configured to be protected from dirt and debris, said shield unit being biased into a stored position having said front side of said tool box being exposed, said shield unit comprising
a housing having a first end, a second end and an outer wall extending therebetween, said outer wall having a slot extending into an interior of said housing, said slot extending between said first end and said second end, said housing being coupled to said front side of said tool box having said housing being horizontally oriented and being aligned with said top side of said tool box, said slot being directed toward said bottom side of said tool box,
a spool being rotatably positioned within said housing, said spool being biased to rotate in a first direction, said spool being urgeable to rotate in a second direction, said spool being oriented to be collinear with said slot, and
a sheet having a first edge and a second edge, said first edge being coupled to said spool.

2. (canceled)

3. (canceled)

4. (canceled)

5. The assembly according to claim 1, wherein said sheet is rolled around said spool when said spool rotates in said first direction such that said sheet is stored within said housing.

6. The assembly according to claim 5, wherein said spool rotates in said second direction when said sheet is drawn downwardly to cover said front side of said tool box.

7. The assembly according to claim 1, further comprising a member being coupled to said sheet, said member being aligned with and being coextensive with said second edge of said sheet, said member having a first surface facing said front side of said tool box.

8. The assembly according to claim 7, wherein said member abuts said outer wall of said housing when said spool rotates in said first direction thereby facilitating said member to be gripped for drawing said sheet outwardly from said housing.

9. The assembly according to claim 8, wherein said member is aligned with said bottom side of said tool box when said sheet is drawn outwardly from said housing to cover said front side of said tool box.

10. The assembly according to claim 9, further comprising a plurality of magnets, each of said magnets being coupled to said first surface of said member, each of said magnets magnetically engaging said front side of said tool box when said sheet is drawn downwardly along said front side of said tool box to retain said sheet to cover said front side of said tool box.

11. A tool box shield assembly being retractably drawn downwardly on a tool box to shield drawers in the tool box, said assembly comprising:
a tool box having a front side, a top side and a bottom side, said front side having a plurality of drawers therein; and
a shield unit being positioned on said tool box, said shield unit being urgeable into a deployed position having said shield unit covering said front side of said tool box wherein said drawers in said tool box are configured to be protected from dirt and debris, said shield unit being biased into a stored position having said front side of said tool box being exposed, said shield unit comprising:
a housing having a first end, a second end and an outer wall extending therebetween, said outer wall having a slot extending into an interior of said housing, said slot extending between said first end and said second end, said housing being coupled to said front side of said tool box having said housing being horizontally oriented and being aligned with said top side of said tool box, said slot being directed toward said bottom side of said tool box;
a spool being rotatably positioned within said housing, said spool being biased to rotate in a first direction, said spool being urgeable to rotate in a second direction, said spool being oriented to be collinear with said slot;
a sheet having a first edge and a second edge, said first edge being coupled to said spool, said sheet being rolled around said spool when said spool rotates in said first direction such that said sheet is stored within said housing, said spool rotating in said second direction when said sheet is drawn downwardly to cover said front side of said tool box;
a member being coupled to said sheet, said member being aligned with and being coextensive with said second edge of said sheet, said member abutting said outer wall of said housing when said spool rotates in said first direction thereby facilitating said member to be gripped for drawing said sheet outwardly from said housing, said member having a first surface facing said front side of said tool box, said member being aligned with said bottom side of said tool box when said sheet is drawn outwardly from said housing to cover said front side of said tool box; and
a plurality of magnets, each of said magnets being coupled to said first surface of said member, each of said magnets magnetically engaging said front side of said tool box when said sheet is drawn downwardly along said front side of said tool box to retain said sheet to cover said front side of said tool box.
